(19) United States
(12) Patent Application Publication
(10) Pub. No.: US 2010/0206247 A1
(43) Pub. Date: Aug. 19, 2010

(54) Adjustable Pet Raincoat

(75) Inventors: Charles T. Cheng, San Jose, CA (US); Fung-Hsiang Pei, San Jose, CA (US); Lawrence Cheng, San Jose, CA (US)

Correspondence Address: Cheng Intellectual Property Group, 1583 Clarkspur Lane, San Jose, CA, 95129, US

(73) Assignee: Charles T. Cheng, San Jose, CA (US)

(21) Appl. No.: 12/490,999

(22) Filed: Jun. 24, 2009

Related U.S. Application Data
(60) Provisional application No. 61/207,677, filed on Feb. 14, 2009.

(51) Int. Cl. A01K 13/00

(52) U.S. Cl. 119/850

(57) ABSTRACT

An adjustable pet raincoat and a method of using the raincoat are disclosed. An adjustable pet raincoat comprises one or more foldable torso covers and an inflatable head cover. Each torso cover has one or more sections and can be fully extended or folded. A torso cover can also be attached to another torso cover to form a bigger one to fit the size of a pet. Torso straps and a chest strap are attached to torso covers and used to anchor the pet raincoat on a pet. In a further embodiment, sections of a torso cover are connected to their neighboring sections only at their middle part of divided lines to allow flexible use of each section.

### CROSS-REFERENCE TO RELATED APPLICATIONS

This application claims priority from U.S. Provisional Application No. 61/207,677 filed on Feb. 14, 2009 and entitled “Pet Raincoat”. This provisional application is herein incorporated by reference.

### BACKGROUND

1. Field of Invention

The present invention relates generally to raincoats. More particularly, the present invention relates to an adjustable raincoat which can be used to cover a growing animal, such as a dog or other pet.

2. Description of the Related Art

Pet owners usually walk their pets periodically throughout the day. When the weather is inclement, it is typical for the pet owners to provide some protections for their pets from rain, snow or sun. Typically, umbrella and raincoat are used to serve the purpose. Carrying an extra umbrella by an owner for a pet is not practical since the pet may be moving around and raincoats for pets are not readily available or well designed. Information relevant to attempts to address these problems can be found in U.S. Pat. Nos. 6,138,611, 6,431,123, 6,584,939, 7,021,246 and 7,036,519, and U.S. Patent Application Publication No. 2003/0029389. However, each one of these references suffers from one or more of the following disadvantages. An umbrella may not be able to completely cover a pet or it may be too bulky to accommodate a large pet. Furthermore, an umbrella is not suitable for a windy condition since it may affect the pet's activities. On the other hand, a raincoat for pets may seem to help but pets come in different sizes and can grow very fast such that the raincoat becomes uncomfortable to wear for the pets and it needs a replacement with a larger raincoat quite often. For the foregoing reasons, there is a need for providing a means to protect a pet without above problems.

### SUMMARY

The present invention is directed to an adjustable pet raincoat that satisfies the need to provide a light, easy to wear raincoat to protect pets from getting wet while accommodating a growing pet with minimum cost by adding extra covers as needed rather than replacing with a new raincoat.

An apparatus for covering and protecting an animal or a pet from bad weather having features of the present invention comprises at least one foldable torso cover. Each torso cover is divided into one or more sections. Two separable cover-to-cover fasteners are located at both front end and back end of each torso cover respectively for attaching to another identical torso cover to form a bigger cover sufficient to cover the animal. An inflatable head cover includes a head portion and a neck portion, and the neck portion of the head cover is connected to the separable cover-to-cover fastener located at the front end of one of the torso cover(s). The head cover is also detachable from the torso cover(s). Two straps are connected to the left end and right end of one of the torso cover(s) for attaching to a pet and the straps are detachable from the torso cover(s).

In a variation on this embodiment, each torso cover is made of waterproof material and includes three or more sections such as front section, center section and rear section. Those sections can be folded along divided lines on the torso cover. Each section of the torso cover(s) is individually inflatable such that pumped air can strengthen the cover to sustain wind or create various shapes for aesthetic purpose. The center section is about twice the size of any of its neighboring sections and has one or more storage compartments that allow the other unused sections to be folded along the divided lines and stored in the storage compartment(s). Furthermore, a leash hole is located at the front end toward the middle of the front section to allow a leash to go through.

In a further variation, each section of a torso cover is partially connected to its neighboring sections at the middle portion which is about half the size of a divided line so that each section can be flexible and used independently in either wrapping around a pet's torso or keeping straight to cover a pet's limbs without worrying its neighboring sections.

In a variation on this embodiment, each section of a torso cover has at least one separable cover-to-cover fasteners at either front end, back end or both ends of the section for attaching to a section of another torso cover when some sections of the torso cover are folded. A protective cover adjacent to each separable cover-to-cover fastener may be used to cover its corresponding separable cover-to-cover fastener not in use.

In a variation on this embodiment, two separable cover-to-strap fasteners closer to the chest of a pet are located to the left and to the right of the leash hole on the front section of a torso cover for the attachment of a chest strap. Furthermore, there are two separable cover-to-strap fasteners on both left side and right side of each section of the torso cover to allow the attachment of torso straps to secure on pet's body.

In a variation on this embodiment, the inflatable head cover that is made of waterproof material and the head portion of the inflatable head cover is made in half-cone shape. The neck portion of the inflatable head cover has a separable cover-to-cover fastener for attachment purpose. Head cover inflated with air can sustain wind and avoid lying on an animal's head that obstruct its vision.

In a variation on this embodiment, each strap has two ends. One end has a separable strap-to-cover fastener for attaching to a torso cover while another end has a separable strap-to-strap fastener for attaching to another strap. The strap also has a strap loop for adjustment purpose to fit a pet's body. Straps can be further categorized as torso straps or chest straps depending on the location of use in a torso cover.

A method of using the adjustable pet cover comprises the use of one or more torso covers depending on the size of a pet. By comparing a torso cover to a pet, an owner can decide if one torso cover is enough. If the torso cover is larger than the size of a pet, one or more sections of the cover can be folded and stored in a storage compartment of the center section. If the pet size is larger than a torso cover, one fully extended cover and a second cover will be attached to each other by connecting their separable cover-to-cover fasteners together. Both covers should be oriented in such a way that their separable cover-to-cover fasteners will face each other and overlap. After selecting appropriate number of torso covers, a pet owner can attach straps to one or more sections of the torso covers around a pet's torso. Finally, a head cover can be inflated and attached to the front section of the torso cover closer to a pet's neck through a separable cover-to-cover fastener on the neck portion of the head cover.

### BRIEF DESCRIPTION OF THE DRAWINGS

These and other features, aspects, and advantages of the present invention will become better understood with regard to the following description, appended claims, and accompanying drawings where:

FIG. 1 illustrates a pet raincoat worn by a dog, in accordance with an embodiment of the present invention.

FIG. 2A shows a detailed view of a torso cover with a hat cover, in accordance with an embodiment of the present invention.

FIG. 2B shows a folded torso cover.

FIG. 3 illustrates two torso covers attached to each other, in accordance with an embodiment of the present invention.

FIG. 4 shows a torso cover, in accordance with one alternative embodiment of the present invention.

FIG. 5 shows an inflatable head cover, in accordance with an embodiment of the present invention.

FIG. 6 is a flow chart illustrating the process of applying an adjustable pet raincoat to a pet.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principle defined herein may be applied to other embodiments and applications without departing from the spirit and scope of the present invention. Thus, the present invention is not intended to be limited to the embodiments shown, but is to be accorded the widest scope consistent with the principle and features disclosed herein.

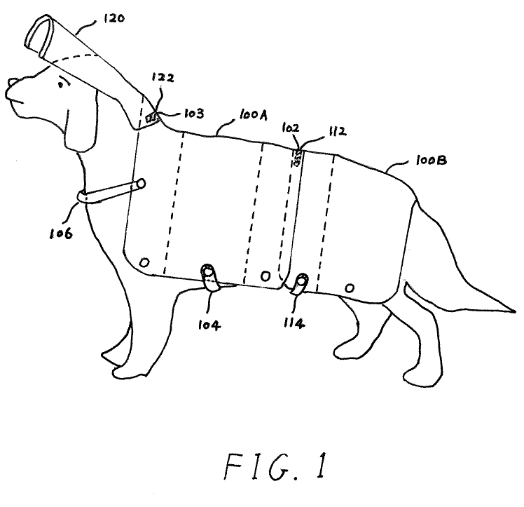

As shown in FIG. 1, a pet raincoat as worn by a dog in accordance with an embodiment of the present invention. Two pieces of waterproof, breathable and foldable covers including a fully extended torso cover and a half folded torso cover respectively, are attached to each other to cover a full grown dog. In FIG. 1, the first cover 100A is attached to the second cover 100B by two separable cover-to-cover fasteners, namely 102 on the first cover and 112 on the second cover. It appears to be only one separable cover-to-cover fastener in FIG. 1 because two separable cover-to-cover fasteners are overlapped. A separable cover-to-cover fastener, preferrably a hook and loop material (e.g. Velcro-™), is in a form of a sheet having complemental parts which adhere to each other when pressed together and separate from each other by moving them apart.

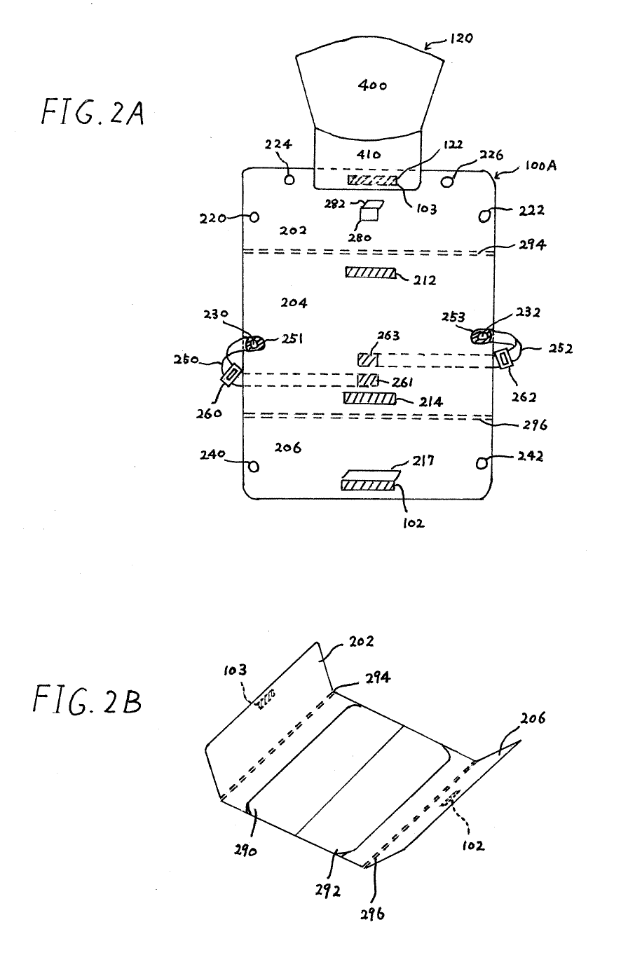

An adjustable torso strap 104 of the first cover 100A and another adjustable torso strap 114 of the second cover 100B are tied to the body of a dog to secure the covers. An optional chest strap 106 can be used by attaching to the front separable cover-to-strap fasteners of the first cover which is described later with reference to FIG. 2A. An inflatable head cover 120 made of waterproof material and having a separable cover-to-cover fastener 122 is attached to another separable cover-to-cover fastener 103 at the front end of the first cover 100A. The length of the head cover is long enough to cover most part of the dog's face and ears.

FIG. 2A shows the detailed view of the torso cover 100A in FIG. 1 together with an inflatable head cover 120 which is also waterproof. This embodiment of the torso cover 100A is divided into three sections—front section 202, center section 204 and rear section 206. Front section 202 and rear section 206 are each roughly half the size of center section 204 to allow them to fold along divided lines 294 and 296 and store in the storage compartments such as pockets located on the opposite surface to where separable cover-to-cover fasteners 212 and 214 are in the center section 204 as described below with reference to FIG. 2B. Note that the size of each section of the foldable cover may vary as long as the center section can accommodate and store the other unused sections. Each section of the torso cover has a separable cover-to-cover fastener on either front end or back end, or two separable cover-to-cover fasteners on both ends to allow an unfolded section to attach to another cover. For instance, front section 202 has one separable cover-to-cover fastener 103 on its front end. The center section 204 has two separable cover-to-cover fasteners 212 and 214 on both front and back ends. Rear section 206 has a separable cover-to-cover fastener 102 on its back end. Each separable cover-to-cover fastener may be covered by a protective cover 217 when it is not in use. Only one protective cover is drawn as an example and many may be used. In addition, each section of the cover has two separable cover-to-strap fasteners on its left end and right end, such as 220 and 222 for the front section 202, 230 and 232 for the center section 204, and 240 and 242 for the rear section 206. Each pair of separable cover-to-strap fasteners on a section allows the attachment of a pair of adjustable straps. For example, torso strap 250 is connected to separable cover-to-strap fastener 230 and torso strap 252 is connected to separable cover-to-strap fastener 232. The torso strap 250 also has a separable strap-to-cover fastener 251 on one end to allow the strap to anchor on the torso cover and another separable strap-to-strap fastener 261 at the other end for attaching to another strap such as 252 by putting their separable strap-to-strap fasteners, namely 261 and 263 together. The “separable cover-to-strap fastener” and “separable strap-to-cover fastener” as used herein can be made in a variety of ways. A separable cover-to-strap fastener and a separable strap-to-cover fastener, such as 230 on the center section 204 of the torso cover and 251 on the torso strap 250 respectively, are a pair for connecting a torso cover and a strap. They can include, but is not limited to, a hook and loop materials (e.g. Velcro-™), buttons, clips or even an opening for 230 together with an enlarged head for 251 that allow the strap to insert into the opening and stay on the torso cover. A pair of separable strap-to-strap fasteners between two straps, such as 261 and 263, can include, but is not limited to, preferably a hook and loop materials (e.g. Velcro-™), buttons, clips or buckles.

Continuing on FIG. 2A, similarly, torso strap 252 has a separable strap-to-cover fastener 253 for connecting to the torso cover 100A and a separable strap-to-strap fastener 263 at the other end for connecting to another strap 250. Each torso strap has a strap loop for adjustment to accommodate the body of a pet, such as loop 260 for strap 250 and loop 262 for strap 252. More than one pair of torso straps may be used depending on pet owner's need by attaching them to the corresponding sections of a torso cover. If only a pair of torso straps are used for a cover, they can be used on any section of the cover to best fit a pet. For example, when two covers are used, one pair of torso straps can be used for openings 230 and 232 of center section of the first torso cover while another pair of torso straps can be used for openings 220 and 222 of front section of the second torso cover, as shown in the case of FIG. 1. A leash hole 280 with a cover 282 in the middle of the front section 202 can allow a pet leash to go through. In addition, two separable cover-to-strap fasteners 224 and 226 which are to the left and right of the leash hole and are roughly equal distance from the leash hole are for the use of a pair of chest straps such as the one 106 in FIG. 1 which shows only one of the pair. An inflatable head cover 120 is shown to attach to the torso cover 100A through a separable cover-to-cover fastener 122 on the neck portion 410 of the head cover 120 and the separable cover-to-cover fastener 103 on the front section 202 of the torso cover 100A.

FIG. 2B shows the opposite side of the torso cover 100A with both front and rear sections are folded along divider lines 294 and 296. Storage compartments such as pockets 290 and 292 are on the opposite side to where separable cover-to-cover fasteners are located on the cover 100A. In FIG. 2B, storage compartments 290 and 292 are on the upper surface where front and rear sections 202 and 206 are folded to, and separable cover-to-cover fasteners 212 and 214 are on the lower surface which are not seen in the figure. Front section 202 is folded and stored inside pocket 290 while rear section 206 is also folded and stored in pocket 292. With only center section 204 in use, this folded cover can be used for a young pet or as an add-on cover to another cover via separable cover-to-cover fasteners 212 and 214 (not shown, see FIG. 2A). Each section of the torso cover may be individually inflatable such that pumped air can strengthen the cover to sustain wind or create various shapes for aesthetic purpose.

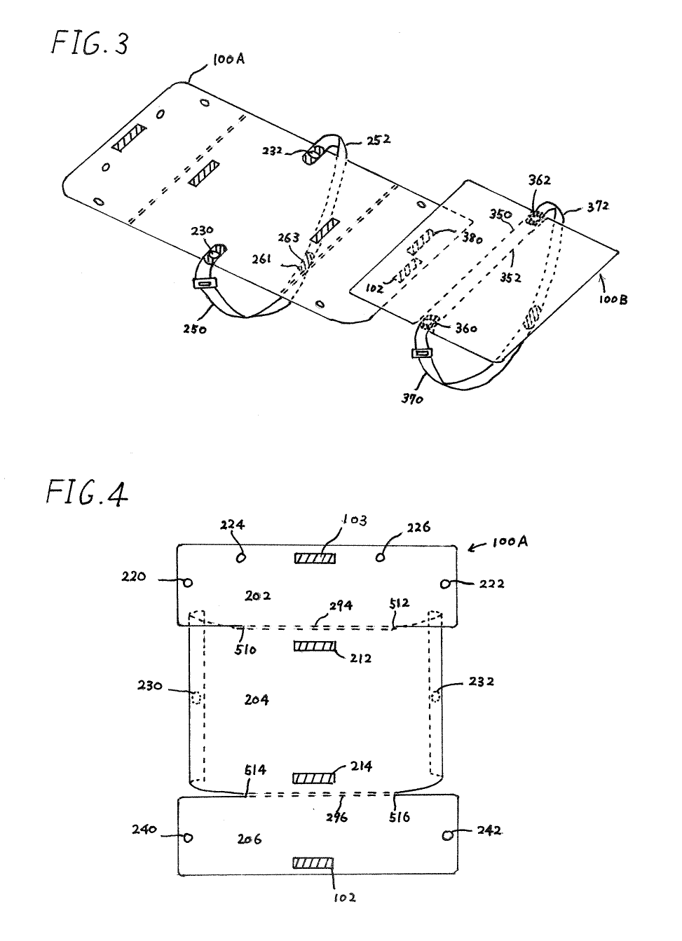

FIG. 3 illustrates how two torso covers 100A and 100B are attached to each other to form a bigger cover for a larger pet. The torso cover 100B is folded with both front section 350 and rear section 352 being stored in their corresponding pockets and the torso cover 100A is completely extended. The cover 100A is oriented to have its side with separable cover-to-cover fasteners facing up and the cover 100B is oriented to have its side with separable cover-to-cover fasteners facing down. The separable cover-to-cover fastener 102 of the cover 100A is placed right below the separable cover-to-cover fastener 380 of the cover 100B. Adjustable torso straps 250 and 252 are attached to separable cover-to-strap fasteners 230 and 232 of cover 100A. The other ends of straps 250 and 252 are attached to each other via separable strap-to-strap fasteners 261 and 263 to form a complete strap around a pet's torso. Similarly, a second pair of adjustable straps 370 and 372 are attached to separable cover-to-strap fasteners 360 and 362 of cover 100B respectively. This configuration of FIG. 3 is appropriate for a mid-size pet. An advantage of this configuration is that a pet owner can reuse the torso cover 100A and add another torso cover 100B when his or her pet has grown to be larger than what the cover 100A can accommodate. The torso cover 100B still has room to accommodate a growing pet by unfolding its non-center sections later. This will save cost of replacing a new raincoat every so often.

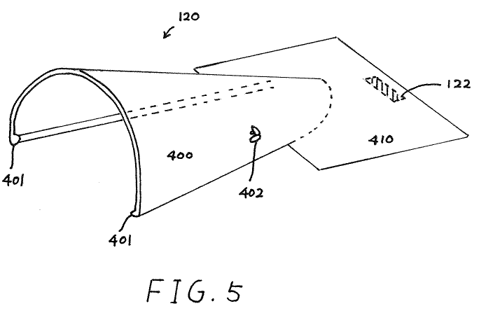

FIG. 4 shows a torso cover in accordance with an alternative embodiment of present invention. The torso cover 100A of FIG. 4 is made the same size or wider than the width of the cover in FIG. 2A so that it can cover the legs of a pet. Each section of the torso cover 100A is partially connected to its neighboring sections only at its middle part of divided lines instead of the whole divided lines. The connected portion is about half the size of a divided line. This configuration allows one section to cover a pet's leg while another section can be curled up and wrapped around the pet's torso. In FIG. 4, the front section 202 and center section 204 are connected to each other only between point 510 and point 512 of the divided line 294. Similarly, the center section 204 and rear section 206 are connected to each other only between point 514 and 516 of the divided line 296. In this embodiment, front section 202 and rear section 206 can be kept straight to cover a pet's leg while center section 204 is wrapped around the pet's body. This example shows how the cover can fit a pet's body contour better because each section is flexible and can be used independently.

FIG. 5 depicts an embodiment of an inflatable waterproof head cover 120. The head cover contains two parts, head portion 400 and neck portion 410. The head portion is made in a half cone shape with an air intake 402. It has reinforced edge 401 to sustain wind. A variation on this embodiment of head cover may be made in different shapes. Head cover inflated with air can sustain wind and avoid lying on an animal's head that may obstruct its vision. The neck portion 410 has a separable cover-to-cover fastener 122 at the lower surface and is used to attach to a torso cover to secure on a pet's neck. This head cover can be pretty much reused for a growing pet.

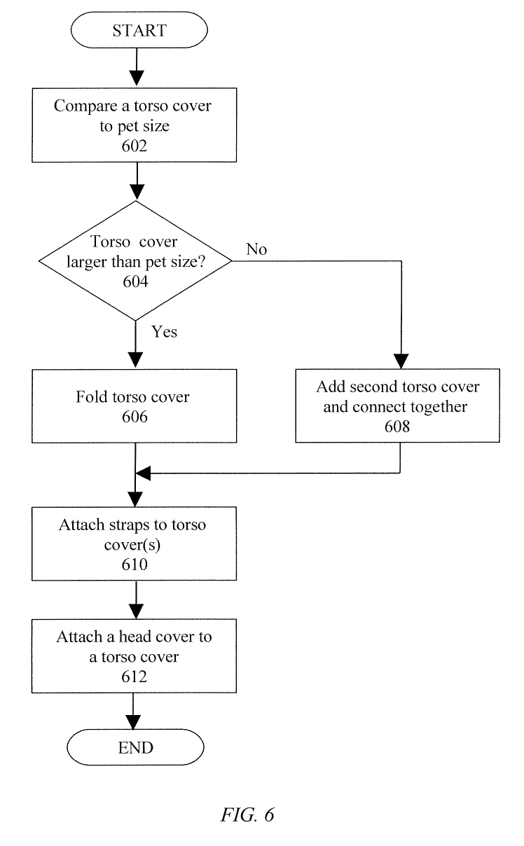

FIG. 6 is a flow chart illustrating the process of applying an adjustable pet raincoat to a pet. The process starts by comparing a torso cover to the size of a pet in step 602 to determine if one torso cover is enough or any folding is required to best fit the pet. With the compared result (step 604), the pet owner can decide to use only one torso cover or add a second torso cover. If a torso cover is larger than the size of the pet (step 604), the pet owner will probably need to fold one or more sections of the torso cover (step 606) and store them in a storage compartment of the center section. If a torso cover is smaller than the size of the pet (step 604), the pet owner needs to add a second torso cover in step 608 or more torso covers depending on how big the pet is. To connect two torso covers together, the separable cover-to-cover fastener of the first cover will face up while the separable cover-to-cover fastener of the second cover will face down to allow both separable fasteners to overlap. After selecting appropriate number of torso covers, the pet owner can attach one or more pairs of straps to one or more sections of the torso cover(s) in step 610 via separable cover-to-strap fasteners and strap-to-cover fasteners, and adjust strap loops to fit the pet. Finally, a head cover can be inflated and attached to the torso cover closer to the pet's neck in step 612 through a separable cover-to-cover fastener on the neck portion of the head cover.

The previous described embodiments of the present invention have many advantages, including reusing sections of a pet raincoat to accommodate a growing pet to avoid the cost of replacement, fitting a pet's body contour better, flexible use of straps and reinforced inflatable raincoat to sustain wind.

The foregoing descriptions of embodiments of the present invention have been presented for purposes of illustration and description only. They are not intended to be exhaustive or to limit the present invention to the form disclosed. Accordingly, many modifications and variations will be apparent to practitioners skilled in the art. Additionally, the above disclosure is not intended to limit the present invention.

1. An apparatus for covering and protecting an animal from bad weather, comprising:
at least one torso cover being foldable, wherein each torso cover divided into one or more sections;
a first separable cover-to-cover fastener located on front end of each torso cover and a second separable cover-to-cover fastener located on back end of each torso cover, whereby said second separable cover-to-cover fastener allows each torso cover to attach to another torso cover to form a bigger cover sufficiently to cover said animal;
an inflatable head cover including a head portion and a neck portion, wherein said neck portion being connected to said first separable cover-to-cover fastener of one of said at least one torso cover and said inflatable head cover being detachable from said at least one torso cover; and
a first strap connected to left end of one of said at least one torso cover and a second strap connected to right end of one of said at least one torso cover for attaching said at least one torso cover to said animal, wherein said first strap and said second strap being detachable from said at least one torso cover.

2. The apparatus of claim 1, wherein each torso cover being waterproof includes at least three sections being a front section, a center section and a rear section, wherein said at least three sections are foldable along divided lines.

3. The apparatus of claim 1, each section of said at least one torso cover is individually inflatable to be wind sustainable or create various shapes.

4. The apparatus of claim 2, said center section of said at least three sections is about twice the size of one of said front section and said rear section.

5. The apparatus of claim 2, said center section of said at least three sections further comprising one or more storage compartments for storing other unused and foldable sections.

6. The apparatus of claim 2, said front section of said at least three sections further comprising a leash hole located at the front end toward the middle of said front section to allow a leash to go through.

7. The apparatus of claim 1, each section of said at least one torso cover is partially connected to its neighboring sections at the middle portion which is about half the size of a divided line.

8. The apparatus of claim 1, each section of said at least one torso cover further comprising at least one separable cover-to-cover fastener at either the front end, the back end or both ends of each section for attachment purpose, each separable cover-to-cover fastener having a protective cover adjacent to itself.

9. The apparatus of claim 6, said front section further comprising a first separable cover-to-strap fastener to the left of said leash hole and a second separable cover-to-strap fastener to the right of said leash hole, wherein said first and said second separable cover-to-strap fasteners are closer to the chest of said animal than other separable cover-to-strap fasteners.

10. The apparatus of claim 1, each of said one or more sections further comprising a separable cover-to-strap fastener on left end and a separable cover-to-strap fastener on right end.

11. The apparatus of claim 1, said inflatable head cover being waterproof, wherein said head portion of said inflatable head cover being in half-cone shape and said neck portion of said inflatable head cover having a separable cover-to-cover fastener for attachment purpose.

12. The apparatus of claim 1, each of said straps having a first end with a separable strap-to-cover fastener for attaching to said at least one torso cover, and a second end with a separable strap-to-strap fastener for attaching to another strap.

13. The apparatus of claim 12, wherein said trap further comprising a strap loop for adjustment purpose.

14. The apparatus of claim 12, wherein said trap is either a torso strap or a chest trap depending on the location of said strap.

15. A method of manufacturing a raincoat for protecting an animal from bad weather, comprising:
providing at least one torso cover being foldable, wherein each torso cover divided into one or more sections;
providing a first separable cover-to-cover fastener located on front end of each torso cover and a second separable cover-to-cover fastener located on back end of each torso cover, whereby said second separable cover-to-cover fastener allows each torso cover to attach to another torso cover to form a bigger cover sufficient to cover said animal;
adding an inflatable head cover including a head portion and a neck portion, wherein said neck portion being connected to said first separable cover-to-cover fastener of one of said at least one torso cover and said inflatable head cover being detachable from said at least one torso cover; and
providing a first strap connected to left end of one of said at least one torso cover and a second strap connected to right end of one of said at least one torso cover for attaching said at least one torso cover to said animal, wherein said first strap and said second strap being detachable from said at least one torso cover.

16. The method of claim 15, wherein each torso cover being waterproof and further including at least three sections being a front section, a center section and a rear section, wherein said at least three sections are foldable along divided lines, said center section being about twice the size of one of its neighboring sections and further including one or more storage compartments.

17. The method of claim 15, each of said one or more sections further including a separable cover-to-strap fastener on left end and a separable cover-to-strap fastener on right end, said at least one torso cover further including a plurality of straps, wherein each strap having a first end with a separable strap-to-cover fastener for attaching to one of said separable cover-to-strap fasteners on each section, and a second end with a separable strap-to-strap fastener for attaching to another strap.

18. A method for using an adjustable pet raincoat, the method comprising:
comparing a first torso cover to a pet size to decide if said first torso cover is enough to cover said pet;
folding one or more sections of said first torso cover into a storage compartment in center section of said first torso cover when said first torso cover is bigger than said pet size; and
adding a second torso cover when said first torso cover is smaller than said pet size and orienting sides with separable cover-to-cover fasteners on said first torso cover and said second torso cover to face each other so that said separable cover-to-cover fasteners of both said first torso cover and said second torso cover can attach to each other.

19. The method of claim 18, wherein subsequently attaching pairs of straps to one or more sections of said torso covers and adjusting said pairs of straps to fit a pet.

20. The method of claim 18, wherein subsequently inflating a head cover and attaching the neck portion of said head cover to front section of said first torso cover.
